(19) United States
(12) Patent Application Publication
(10) Pub. No.: US 2017/0177620 A1
(43) Pub. Date: Jun. 22, 2017

(54) CONSTRUCTING FINGERPRINT DATABASE AND POSITIONING BASED ON FINGERPRINT DATABASE

(71) Applicant: Alibaba Group Holding Limited, Grand Cayman (KY)

(72) Inventor: Jie Zhang, Hangzhou (CN)

(21) Appl. No.: 15/381,806

(22) Filed: Dec. 16, 2016

(30) Foreign Application Priority Data
Dec. 17, 2015 (CN) 201510955117.X

(51) Int. Cl. G06F 17/30; G01S 5/02; H04W 4/02; G06Q 20/32; H04W 4/04; H04B 17/318

(52) U.S. Cl. CPC G06F 17/30241; H04W 4/043; H04B 17/318; H04W 4/027; G06Q 20/325; G01S 5/02

(57) ABSTRACT

The present disclosure provides various fingerprint database construction methods and apparatuses and positioning methods and apparatuses based on fingerprint database. An example fingerprint database constructing method includes: receiving service requests sent by client terminals having a service relationship with a target service object, and receiving location fingerprint data sent by the client terminals in the process of sending the service requests; determining the location of the target service object according to indication information, and using the location of the target service object as a location point corresponding to the location fingerprint data; and acquiring a fingerprint feature corresponding to the location point according to the location fingerprint data, and establishing a corresponding relationship between the location point and the fingerprint feature, to generate a fingerprint database. The present techniques improve the accuracy of indoor positioning.

### CROSS REFERENCE TO RELATED APPLICATION

The present disclosure claims the benefit of Chinese Patent Application Number 201510955117.X filed Dec. 17, 2015, entitled “Method and Apparatus for Constructing Fingerprint Database, and Positioning Method and Apparatus Based on the Fingerprint Database” which is hereby incorporated by reference in its entirety.

### TECHNICAL FIELD

The present disclosure relates to the field of communication technologies, and, more particularly, to a method and apparatus for constructing a fingerprint database, and a method and apparatus for positioning based on the fingerprint database.

### BACKGROUND

Global Positioning Systems (GPS) have been widely used in various industries, but it have an evident defect, i.e., poor indoor positioning, and thus cannot meet the coverage and accuracy requirements of indoor positioning. Hence, a positioning method based on a Wi-Fi signal and/or a base station signal has emerged.

The process of the positioning method based on a Wi-Fi signal and/or a base station signal is as follows: a mobile terminal may detect a nearby base station signal and/or WI-FI signal and send the base station signal and/or WI-FI signal to a server, and the server queries corresponding location points stored in a fingerprint database in the server according to the base station signal and/or WI-FI signal, and sends the query result to the mobile terminal, to achieve positioning. However, all these need to be based on a pre-generated fingerprint database.

In conventional techniques, it is common to go to the field to manually collect location fingerprint data near a specified location point by using dedicated collection software or a dedicated collection device, and then extract a fingerprint feature of the location point from the collected location fingerprint data and store the fingerprint feature and the location point in a corresponding manner, thereby generating a fingerprint database. Such a method of manually constructing a fingerprint database involves complicated and time-consuming operations and is inefficient.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

Multiple aspects of the present disclosure provide a method and apparatus for constructing a fingerprint database, and a method and apparatus for positioning based on the fingerprint database, to improve the accuracy of indoor positioning.

In an aspect of the present disclosure, a fingerprint database constructing method is provided, including:

collecting, by a client terminal, location fingerprint data at the location of a target service object, the target service object referring to a service object having a service relationship with the client terminal; and

sending, by the client terminal, a service request to a server terminal, and sending the location fingerprint data to the server terminal in the process of sending the service request, so that the server terminal generates a fingerprint database according to the service request and the location fingerprint data,

wherein the service request includes indication information indicative of the location of the target service object.

In an aspect of the present disclosure, a fingerprint database constructing method is provided, including:

receiving service requests sent by client terminals having a service relationship with a target service object, and receiving location fingerprint data sent by the client terminals in the process of sending the service requests, the location fingerprint data referring to location fingerprint data at the location of the target service object, and the service requests including indication information indicative of the location of the target service object;

determining the location of the target service object according to the indication information, and using the location of the target service object as a location point corresponding to the location fingerprint data; and

acquiring a fingerprint feature corresponding to the location point according to the location fingerprint data, and establishing a corresponding relationship between the location point and the fingerprint feature, to generate a fingerprint database.

In an aspect of the present disclosure, a fingerprint database based positioning method is provided, including:

step-counting a user holding a terminal device according to real-time collected sensor data that reflects a motion state of the terminal device, to acquire at least two time periods during which the user moves and a movement direction corresponding to each time period in the at least two time periods;

calculating fingerprint features corresponding to the time periods according to location fingerprint data collected real-time in the time periods; and

querying a pre-generated fingerprint database according to the movement directions and the fingerprint features corresponding to the time periods, to determine the location of the user, the fingerprint database storing location points and fingerprint features corresponding to the location points.

In an aspect of the present disclosure, a fingerprint database constructing apparatus is provided, which is implemented in a client terminal, and the apparatus includes:

a collection module, configured to collect location fingerprint data at the location of a target service object, the target service object referring to a service object having a service relationship with the client terminal; and

a sending module, configured to send a service request to a server terminal, and send the location fingerprint data to the server terminal in the process of sending the service request, so that the server terminal generates a fingerprint database according to the service request and the location fingerprint data;

wherein the service request includes indication information indicative of the location of the target service object.

In an aspect, the present disclosure provides a fingerprint database constructing apparatus, which is implemented in a server terminal, and the apparatus includes:

a receiving module, configured to receive service requests sent by client terminals having a service relationship with a target service object, and receive location fingerprint data sent by the client terminals in the process of sending the service requests; the location fingerprint data referring to location fingerprint data at the location of the target service object, and the service requests including indication information indicative of the location of the target service object;

a determination module, configured to determine the location of the target service object according to the indication information, and use the location of the target service object as a location point corresponding to the location fingerprint data;

an acquisition module, configured to acquire a fingerprint feature corresponding to the location point according to the location fingerprint data; and

a generation module, configured to establish a corresponding relationship between the location point and the fingerprint feature, to generate a fingerprint database.

In an aspect of the present disclosure, a fingerprint database based positioning apparatus is provided, including:

a step-counting module, configured to step-count a user holding a terminal device according to real-time collected sensor data that reflects a motion state of the terminal device, to acquire at least two time periods during which the user moves and a movement direction corresponding to each time period in the at least two time periods;

a feature calculation module, configured to calculate fingerprint features corresponding to the time periods according to location fingerprint data real-time collected in the time periods; and

a location determination module, configured to query a pre-generated fingerprint database according to the movement directions and the fingerprint features corresponding to the time periods, to determine the location of the user, the fingerprint database storing location points and fingerprint features corresponding to the location points.

In the present disclosure, a client terminal collects location fingerprint data at the location of a target service object, and sends the location fingerprint data to a server terminal in a process of sending a service request, and the server terminal receives the location fingerprint data in a process of receiving the service request, and builds a fingerprint database according to the service request and the location fingerprint data. Compared with the solution of manually collecting and constructing a fingerprint database in the conventional techniques, in the present disclosure, a client terminal executing a service automatically collects location fingerprint data and, in a process of transmitting a service request, transmits the location fingerprint data to a server terminal, thus constructing a fingerprint database. The techniques of the present disclosure save the complicated operation of manually collecting the location fingerprint data and improve the efficiency of constructing the fingerprint database.

### BRIEF DESCRIPTION OF THE DRAWINGS

To describe the technical solutions in the example embodiments of the present disclosure more clearly, accompanying drawings to be used in the description about the example embodiments or the conventional techniques are introduced briefly in the following. Apparently, the accompanying drawings described in the following are only some example embodiments of the present disclosure, and those of ordinary skill in the art may further obtain other accompanying drawings according to the accompanying drawings without making creative efforts.

FIG. 1 is a schematic flow chart of a fingerprint database constructing method according to an example embodiment of the present disclosure;

FIG. 2 is a schematic flow chart of a fingerprint database constructing method according to another example embodiment of the present disclosure;

FIG. 3 is a schematic structural diagram of a fingerprint database constructing apparatus according to further another example embodiment of the present disclosure;

FIG. 4 is a schematic structural diagram of a fingerprint database constructing apparatus according to further another example embodiment of the present disclosure;

FIG. 5 is a schematic flow chart of a fingerprint database based positioning method according to further another example embodiment of the present disclosure;

FIGS. 6a-6e are schematic diagrams illustrating positioning of a user in combination with a fingerprint database according to further another example embodiment of the present disclosure;

FIG. 7 is a schematic structural diagram of a positioning system in an offline consumption scenario according to further another example embodiment of the present disclosure; and

FIG. 8 is a schematic structural diagram of a fingerprint database based positioning apparatus according to further another example embodiment of the present disclosure.

### DETAILED DESCRIPTION

In order to make the objectives, technical solutions, and advantages of the example embodiments of the present disclosure clearer, the technical solutions in the example embodiments of the present disclosure are described clearly and completely below with reference to the accompanying drawings in the example embodiments of the present disclosure. Apparently, the example embodiments described are some and not all of the embodiments of the present disclosure. All the other embodiments obtained by those of ordinary skill in the art without making creative efforts fall in the protection scope of the present disclosure.

With respect to the problems such as complicated operations and low efficiency of manually constructing a fingerprint database in the conventional techniques, the present disclosure provides a fingerprint database constructing solution. The main principle is as follows: with reference to some location-related service scenarios, a service process is combined with constructing of a location fingerprint database, to implement automatic collection of location fingerprint data, and the location fingerprint data is transmitted to a server terminal in a process of transmitting a service request, thereby constructing the fingerprint database. This saves the complicated operation of manually collecting the location fingerprint data and improves the efficiency of constructing the fingerprint database.

The technical solution of the present disclosure is described below in detail by specific example embodiments from the perspective of a client terminal and a server terminal, respectively.

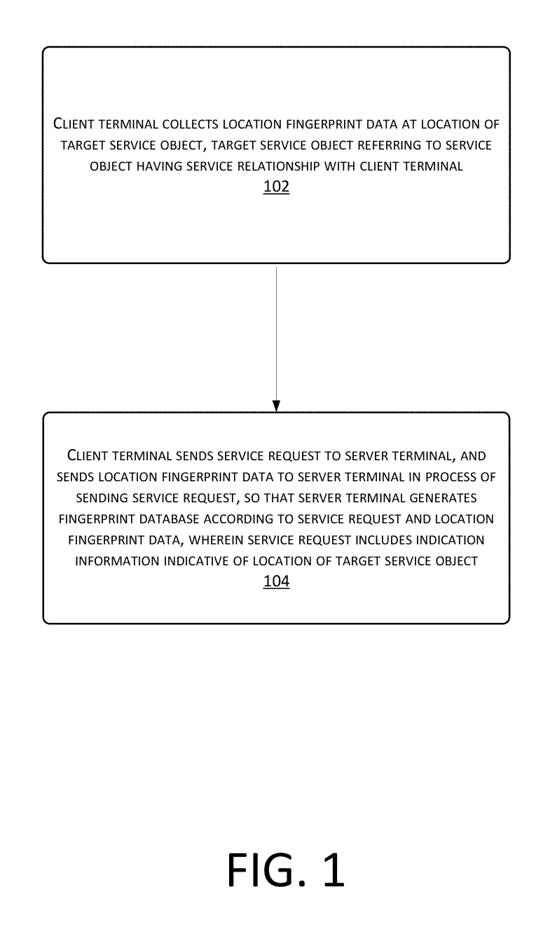

FIG. 1 is a schematic flow chart of a fingerprint database constructing method according to an example embodiment of the present disclosure. As shown in FIG. 1, the method includes:

102. A client terminal collects location fingerprint data at the location of a target service object, the target service object referring to a service object having a service relationship with the client terminal.

104. The client terminal sends a service request to a server terminal, and sends the location fingerprint data to the server terminal in the process of sending the service request, so that the server terminal generates a fingerprint database according to the service request and the location fingerprint data, wherein the service request includes indication information indicative of the location of the target service object.

This example embodiment provides a fingerprint database constructing method, which is described mainly from the perspective of a service client terminal (hereinafter referred to as a client terminal for short) at a user side.

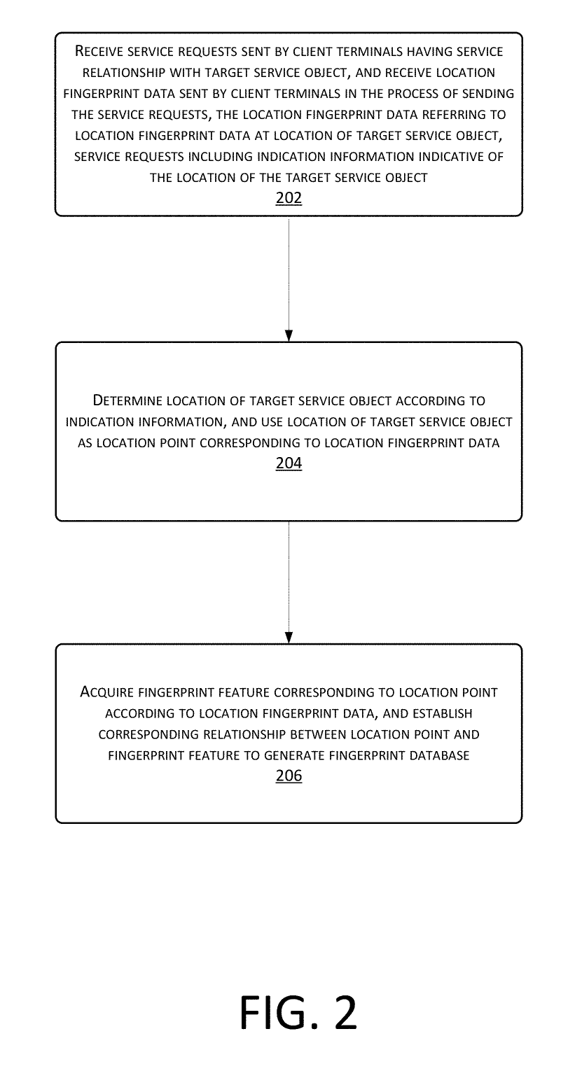

FIG. 2 is a schematic flow chart of a fingerprint database constructing method according to another example embodiment of the present disclosure. As shown in FIG. 2, the method includes:

202. The present techniques receive service requests sent by client terminals having a service relationship with a target service object, and receive location fingerprint data sent by the client terminals in the process of sending the service requests, the location fingerprint data referring to location fingerprint data at the location of the target service object, and the service requests include indication information indicative of the location of the target service object.

204. The present techniques determine the location of the target service object according to the indication information, and use the location of the target service object as a location point corresponding to the location fingerprint data.

206. The present techniques acquire a fingerprint feature corresponding to the location point according to the location fingerprint data, and establish a corresponding relationship between the location point and the fingerprint feature, to generate a fingerprint database.

This example embodiment provides a fingerprint database constructing method, which is described mainly from the perspective of a service server terminal (referred to as a server terminal for short).

The main principle of the fingerprint database method provided in the above example embodiment is as follows: a client terminal transmits location fingerprint data to a server terminal in a process of transmitting a service request to the server terminal, so that the server terminal builds a fingerprint database according to the service request and the location fingerprint data, to improve the efficiency of constructing the fingerprint database.

In the above example embodiment, the target service object refers to a service object having a service relationship with the client terminal. For example, the target service object is a physical object having a geographical location. For example, it may be a physical store, such as a shopping mall, a shop in a shopping mall, a supermarket, a restaurant, a convenience store, a gaming hall, etc. According to different target service objects, services occurring between the client terminal and the target service objects also vary, so involved service requests may also be different. For example, if the target service object is some physical stores that provide offline consumption for users, the service request is a payment request. For another example, if the target service object is some physical stores that provide download services for users, the service request may be a download request.

In the above example embodiment, functions of the client terminal and the server terminal are expanded. The client terminal not only helps a user to accomplish a desired service but also has functions of collecting data and uploading the collected data. The service terminal, in addition to service processing, also has functions of constructing a fingerprint database, positioning and so on.

Specifically, the client terminal collects location fingerprint data at the location of a target object. The location fingerprint data refers to some information that identifies or positions the location of the target object, which may include at least one of the following types: Wi-FI signal strength, Bluetooth signal strength, base station signal strength, and geomagnetic signal strength.

If the location fingerprint data includes the Wi-Fi signal strength, the client terminal may collect a Wi-Fi signal by using a signal collection module; if the location fingerprint data includes the Bluetooth signal strength, the client terminal may collect a Bluetooth signal by using a signal collection module; if the location fingerprint data includes the base station signal strength, the client terminal may receive, by using a communication module on the terminal device, a signal sent by a base station; and if the location fingerprint data includes the geomagnetic signal strength, the client terminal may collect a geomagnetic signal by using an electronic compass on the terminal device.

Meanwhile, the client terminal initiates a service request, for example, a payment request, to the server terminal, and sends the collected location fingerprint data to the server terminal in the process of sending the service request to the server terminal, so that the server terminal constructs a fingerprint database. The fingerprint database needs to include a location point and a fingerprint feature corresponding to the location point. In this example embodiment, the location point is the location of the target service object. In order to facilitate determining, by the server terminal, the location of the target service object, it is necessary to carry, in the service request, indication information that indicates the location of the target service object. The fingerprint feature is acquired according to the location fingerprint data.

In an optional implementation, the indication information may be the location of the target service object. For example, a new field may be added to the service request, and the information of the location of the target service object is carried by the newly added field.

In another optional implementation, considering that there is a service relationship between the client terminal and the target service object, the server request may generally carry an identifier of the target service object. An identifier of a service object has uniqueness, and thus the identifier of the target service object can uniquely determine the location of the target service object. Based on this, the identifier of the target service object carried in the service request can be directly used as the indication information indicative of the location of the target service object. The implementation does not need to modify the service request, is easier to implement, and is more compatible with the existing service process.

For example, there are generally multiple client terminals having a service relationship with the target service object, and the client terminals may have a service relationship with the target service object at the same time, or may have a service relationship with the target service object at different times. For example, lots of customers go shopping in the same supermarket, and these customers may go shopping in the supermarket at the same time, or may go shopping in the supermarket at different times. Each customer has his/her own client terminal. Each client terminal collects location fingerprint data at the location of the target service object in the above manner and sends the collected location fingerprint data in a process of sending a service request.

The server terminal receives the service requests sent by the client terminals and receives the location fingerprint data sent by the client terminals in the process of sending the service requests. The client terminals may send the service requests and the location fingerprint data at the same time. Then, the server terminal acquires, from the service requests, indication information indicative of the location of the target service object, determines the location of the target service object according to the indication information, and uses the location of the target service object as a location point corresponding to the received location fingerprint data. In addition, the server terminal may obtain a fingerprint feature corresponding to the location point according to the location fingerprint data. After the location point and the fingerprint feature corresponding to the location point are determined, a corresponding relationship between the location point and the fingerprint feature corresponding to the location point can be established. After corresponding relationships between a great number of location points and fingerprint features corresponding to the location points are established, a fingerprint database is constructed.

Optionally, if the indication information in the service request is the location of the target service object, the server terminal may directly acquire, from the service request, the indication information (i.e., the location of the target service object) as a location point.

Optionally, if the indication information in the service request is an identifier of the target service object, the server terminal may determine the location of the target service object according to the identifier of the target service object. Specifically, the server terminal may employ, but not limited to, the following two manners:

In an implementation, the server terminal may search in a map according to the identifier of the target service object, to determine the location of the target service object.

In an implementation, the server terminal may pre-acquire identifiers of service objects and locations of the service objects, and establish a corresponding relationship between the identifiers of the service objects and the locations of the service objects, which is referred to as a corresponding relationship between object identifiers and object locations for short. Based on this, the server terminal may query the preset corresponding relationship between object identifiers and object locations according to the identifier of the target service object, to determine the location of the target service object.

In the above process, all the location fingerprint data received by the server terminal is used for describing the target service object. Simply, the server terminal may acquire one of the location fingerprint data as a fingerprint feature corresponding to the location of the target service object. Alternatively, the server terminal may also perform numerical processing on the location fingerprint data, to obtain a fingerprint feature.

It should be noted that, if the location fingerprint data belongs to one type of location fingerprint data, for example, the location fingerprint data belongs to Wi-Fi signal strength, or belongs to Bluetooth signal strength, or belongs to geomagnetic signal strength, numerical processing may be directly performed on the location fingerprint data. If the location fingerprint data includes at least two types of location fingerprint data, numerical processing on various types of location fingerprint data may be performed respectively, to obtain various types of fingerprint features; and then establish a corresponding relationship between the location point and the various types of fingerprint features, to generate a fingerprint database.

For example, assuming some of the location fingerprint data belongs to Bluetooth signal strength and other location fingerprint data belongs to geomagnetic signal strength, it is feasible to perform numerical processing on the Bluetooth signal strength to obtain a Bluetooth fingerprint feature and perform numerical processing on the geomagnetic signal strength to obtain a geomagnetic fingerprint feature, and then establish corresponding relationships between the location point and the Bluetooth fingerprint feature as well as between the location point and the geomagnetic fingerprint feature.

Manners of the above numerical processing include but are not limited to: arithmetically averaging all the location fingerprint data, or arithmetically averaging the location fingerprint data remained after removal of the maximum value and the minimum value, or arithmetically averaging the maximum value and the minimum value, and so on.

Further, the location fingerprint data at the location of the target service object may change over time. For example, for an access point (AP), with the variation of the power thereof, the strength of an emitted signal may also change. For another example, due to application demands, new location fingerprint data may be added. For instance, there is no Bluetooth signal originally, but a Bluetooth AP is newly added later. Based on this, in order to enable the fingerprint feature in the fingerprint database to reflect the location point accurately, after the fingerprint database is constructed, it is necessary to continuously acquire new location fingerprint data at the location of the target service object; and the fingerprint database is updated according to the new location fingerprint data. For ease of differentiation, in this example embodiment, the location fingerprint data at the location of the target service object acquired after the fingerprint database is constructed is referred to as new location fingerprint data.

The updating of the fingerprint database specifically refers to updating the fingerprint feature in the fingerprint database.

With respect to the target service object, as time passes, client terminals having a service relationship therewith emerge continuously. The client terminals may be client terminals that have had a service relationship with the target service object before and may also be client terminals that have a service relationship with the target service object for the first time. These client terminals may also continuously collect new location fingerprint data at the location of the target service object, and may also send the new location fingerprint data to the server terminal in a process of sending service requests to the server terminal.

Based on the above, the server terminal may acquire the new location fingerprint data at the location of the target service object specifically in the following manner: receiving new location fingerprint data sent, in a process of sending service requests, by client terminals having a service relationship with the target service object after the fingerprint database is constructed.

To sum up, in the present disclosure, a client terminal cooperates with a server terminal, the client terminal collects location fingerprint data at the location of a target service object, and sends the location fingerprint data to the server terminal in a process of sending a service request, and the server terminal receives the location fingerprint data in a process of receiving the service request, and builds a fingerprint database according to the service request and the location fingerprint data. Compared with the solution of manually collecting and constructing a fingerprint database in the conventional techniques, in the present disclosure, a client terminal executing a service automatically collects location fingerprint data and, in a process of transmitting a service request, transmits the location fingerprint data to a server terminal, thus constructing a fingerprint database. This saves the complicated operation of manually collecting the location fingerprint data and improves the efficiency of constructing the fingerprint database.

At present, more and more offline consumption scenarios need to position users with an indoor positioning method, and then push various information such as special offers and sale promotions to the users according to the positioning result. For example, a fingerprint database based positioning method may be employed, and it is necessary to firstly build a fingerprint database before the users are positioned by using the fingerprint database based positioning method. With the method of constructing a fingerprint database provided in this example embodiment, in combination with a payment process in an offline consumption scenario, location fingerprint data at the locations of businesses is collected and uploaded to a payment platform, so that the payment platform constructs a fingerprint database by combining the locations of the businesses and the location fingerprint data.

The process of creating a fingerprint database in the present disclosure is described in detail by taking an example that a user is in the offline consumption scenario. In the offline consumption scenario, the target service object is a business, the client terminal is a payment application on a user terminal device, for example, Alipay™, WeChat or the like, and the server terminal is a server terminal corresponding to the payment application, or referred to as a payment platform. Specifically, after the user goes to a business in a shopping mall to consume, for example, do shopping, eating and so on, the user sends a payment request to the payment platform via a payment application on the terminal device. During this period, the payment application may collect location fingerprint data near the business, for example, Wi-Fi signals, and then send the location fingerprint data to the payment platform in the process of sending the payment request to the payment platform, wherein the payment request carries an identifier of the business, for example, name or id or the like. The payment platform receives the payment request sent by the payment application. On one hand, the payment platform performs payment processing according to the payment request, that is, deducts the amount of consumption from the user's account and transfers the amount into the business's account, wherein the payment platform may determine the business's account according to the identifier of the business; and on the other hand, the payment platform determines the location of the business according to the identifier of the business in the payment request, extracts a fingerprint feature from the received location fingerprint data, for example, average strength of the Wi-Fi signals, and then establishes a corresponding relationship between the location of the business and the fingerprint feature.

For each business in the shopping mall, a corresponding relationship between the location of the business and a fingerprint feature is created using the same method described above, thus forming a fingerprint database corresponding to the entire shopping mall. Based on this, users going to the shopping mall to consume are positioned subsequently according to the fingerprint database, so that information such as special offers and sales promotion is pushed to the users timely.

It should be noted that, to make the description simple, the foregoing method example embodiments are expressed as a combination of a series of actions. However, those skilled in the art should know that the present disclosure is not limited by the described action order, because some steps may be performed in other orders or at the same time according to the present disclosure. In addition, those skilled in the art should also know that the example embodiments described in the specification are all example embodiments, and the actions and modules involved are not necessarily mandatory for the present disclosure.

In the foregoing example embodiments, the description of each example embodiment has its own focus; for the content that is not detailed in a certain example embodiment, reference can be made to the relevant description of another example embodiment.

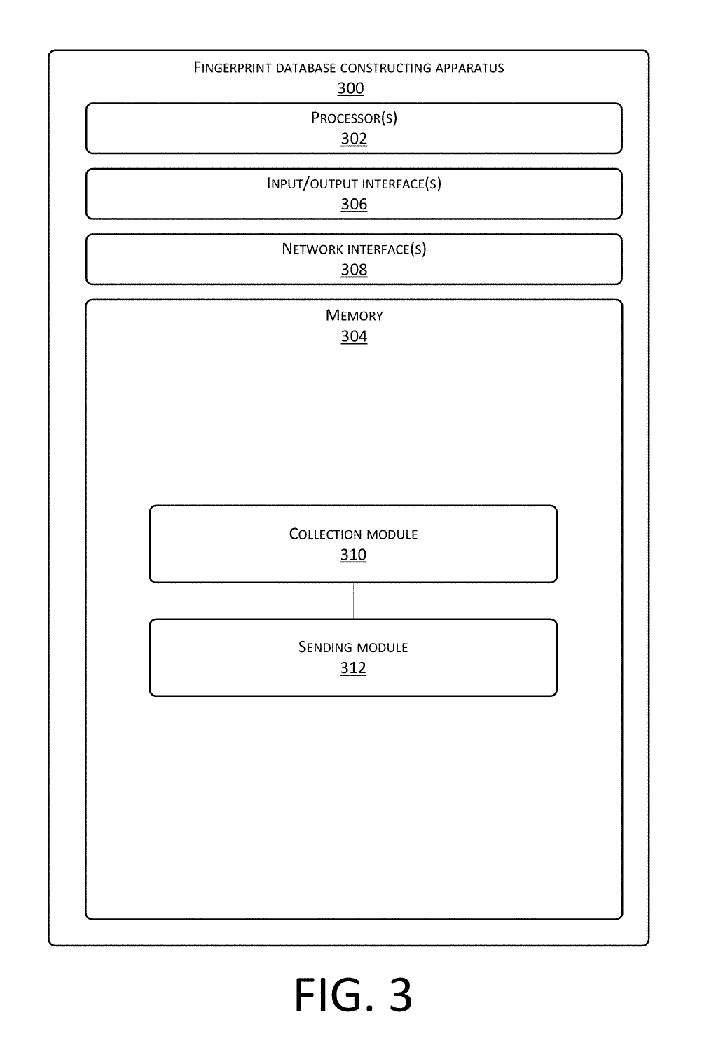

FIG. 3 is a schematic structural diagram of a fingerprint database constructing apparatus 300 according to another example embodiment of the present disclosure.

As shown in FIG. 3, the fingerprint database constructing apparatus 300 may include one or more processor(s) 302 or data processing unit(s) and memory 304. The fingerprint database constructing apparatus 300 may further include one or more input/output interface(s) 306, and network interface(s) 308. The memory 304 is an example of computer readable media.

The memory 304 may store therein a plurality of modules or units including a collection module 310 and a sending module 312.

The collection module 310 is configured to collect location fingerprint data at the location of a target service object, the target service object referring to a service object having a service relationship with the client terminal.

The sending module 312 is configured to send a service request to a server terminal, and send the location fingerprint data collected by the collection module 310 to the server terminal in the process of sending the service request, so that the server terminal generates a fingerprint database according to the service request and the location fingerprint data, wherein the service request includes indication information indicative of the location of the target service object.

The target service object refers to a service object having a service relationship with the client terminal. For example, the target service object is a physical object having a geographical location. For example, it may be a physical store, such as a shopping mall, a shop in a shopping mall, a supermarket, a restaurant, a convenience store, a gaming hall, etc. According to different target service objects, services occurring between the client terminal and the target service objects also vary, so involved service requests may also be different. For example, if the target service object is some physical stores that provide offline consumption for users, the service request is a payment request. For another example, if the target service object is some physical stores that provide download services for users, the service request may be a download request.

In an optional implementation, the location fingerprint data includes at least one of the following types: Wi-FI signal strength, Bluetooth signal strength, base station signal strength, and geomagnetic signal strength.

In an optional implementation, the indication information for indicating the location of the target service object in the service request may be the location of the target service object. Alternatively, the indication information for indicating the location of the target service object in the service request may be an identifier of the target service object.

The fingerprint database constructing apparatus provided in this example embodiment is implemented in a client terminal, and by collecting location fingerprint data at the location of a target service object, and sending the location fingerprint data to a server terminal in a process of sending a service request to the server terminal, it enables the server terminal to build a fingerprint database according to the service request and the location fingerprint data. Compared with the solution of manually collecting and constructing a fingerprint database in the conventional techniques, in the present disclosure, a fingerprint database constructing apparatus in a client terminal automatically collects location fingerprint data and, in a process of transmitting a service request, transmits the location fingerprint data to a server terminal, thus constructing a fingerprint database. This saves the complicated operation of manually collecting the location fingerprint data and improves the efficiency of constructing the fingerprint database.

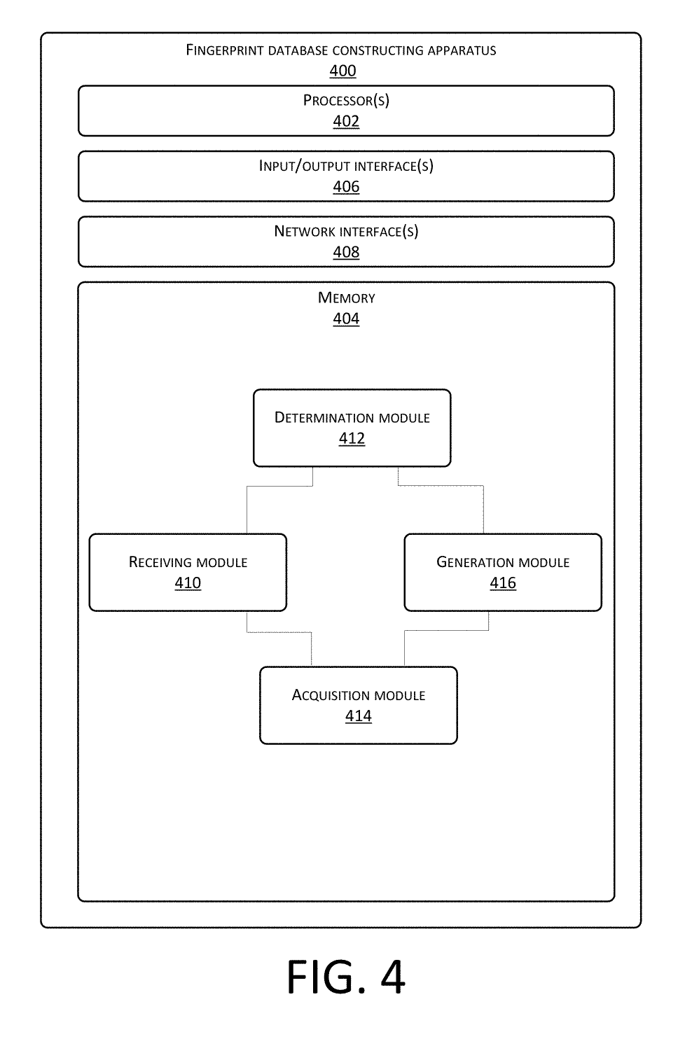

FIG. 4 is a schematic structural diagram of a fingerprint database constructing apparatus 400 according to another example embodiment of the present disclosure. The apparatus is implemented in a server terminal. As shown in FIG. 4, the fingerprint database constructing apparatus 400 may include one or more processor(s) 402 or data processing unit(s) and memory 404. The fingerprint database constructing apparatus 400 may further include one or more input/output interface(s) 406, and network interface(s) 408. The memory 404 is an example of computer readable media.

The memory 404 may store therein a plurality of modules or units including a receiving module 410, a determination module 412, an acquisition module 414 and a generation module 416.

The receiving module 410 is configured to receive service requests sent by client terminals having a service relationship with a target service object, and receive location fingerprint data sent by the client terminals in the process of sending the service requests, the location fingerprint data referring to location fingerprint data at the location of the target service object, and the service requests including indication information indicative of the location of the target service object.

The determination module 412 is configured to determine the location of the target service object according to the indication information received by the receiving module 410, and use the location of the target service object as a location point corresponding to the location fingerprint data.

The acquisition module 414 is configured to acquire, according to the location fingerprint data received by the receiving module 410, a fingerprint feature corresponding to the location point determined by the determination module 412.

The generation module 416 is configured to establish a corresponding relationship between the location point determined by the determination module 412 and the fingerprint feature acquired by the acquisition module 414, to generate a fingerprint database.

The target service object refers to a service object having a service relationship with the client terminal. Preferably, the target service object is a physical object having a geographical location, for example, it may be a physical store, such as a shopping mall, a shop in a shopping mall, a supermarket, a restaurant, a convenience store, a gaming hall, etc. According to different target service objects, services occurring between the client terminal and the target service objects also vary, so involved service requests may also be different. For example, if the target service object is some physical stores that provide offline consumption for users, the service request is a payment request. For another example, if the target service object is some physical stores that provide download services for users, the service request may be a download request.

In an optional implementation, the location fingerprint data includes at least one of the following types: Wi-FI signal strength, Bluetooth signal strength, base station signal strength, and geomagnetic signal strength.

In an optional implementation, the indication information for indicating the location of the target service object in the service request may be the location of the target service object. Alternatively, the indication information for indicating the location of the target service object in the service request may be an identifier of the target service object.

In an optional implementation, the indication information is an identifier of the target service object. Based on this, the determination module 412 may be specifically configured to:

search in a map according to the identifier of the target service object, to determine the location of the target service object; or

query a preset corresponding relationship between object identifiers and object locations according to the identifier of the target service object, to determine the location of the target service object.

In an optional implementation, the acquisition module 414 may be specifically configured to perform numerical processing on the location fingerprint data to obtain the fingerprint feature.

Further, the location fingerprint data includes at least two types of location fingerprint data. Based on this, the acquisition module 414 may be specifically configured to: perform numerical processing on various types of location fingerprint data respectively to obtain various types of fingerprint features. Correspondingly, the generation module 416 may be specifically configured to: establish a corresponding relationship between the location point and the various types of fingerprint features, to generate the fingerprint database.

Further, the fingerprint database constructing apparatus 400 may further include an update module (not shown in FIG. 4) stored on memory 404.

The update module is configured to acquire new location fingerprint data at the location of the target service object, and update the fingerprint database according to the new location fingerprint data. The updating of the fingerprint database refers to updating the fingerprint feature in the fingerprint database.

With respect to the target service object, as time goes on, client terminals having a service relationship therewith emerge continuously. The client terminals emerging may be client terminals that have had a service relationship with the target service object before and may also be client terminals that have a service relationship with the target service object for the first time. These client terminals may also continuously collect new location fingerprint data at the location of the target service object, and may also send the new location fingerprint data to the server terminal in a process of sending service requests to the server terminal. For ease of differentiation, in this example embodiment, the location fingerprint data at the location of the target service object acquired after the fingerprint database is constructed is referred to as new location fingerprint data.

Based on the above, when acquiring the new location fingerprint data at the location of the target service object, the update module may specifically receive new location fingerprint data sent, in a process of sending service requests, by client terminals having a service relationship with the target service object after the fingerprint database is constructed.

The fingerprint database constructing apparatus provided in this example embodiment is implemented in a server terminal, and in coordination with the fingerprint database constructing apparatus implemented in a client terminal, it receives location fingerprint data in a process of receiving a service request, and builds a fingerprint database according to the service request and the location fingerprint data. Compared with the solution of manually collecting and constructing a fingerprint database in the conventional techniques, in the present disclosure, the fingerprint database constructing apparatus in the client terminal automatically collects location fingerprint data and, in a process of transmitting a service request, transmits the location fingerprint data to a server terminal, thus constructing a fingerprint database. This saves the complicated operation of manually collecting the location fingerprint data and improves the efficiency of constructing the fingerprint database.

In some service scenarios, it may be necessary to position users and then push related information to the users. For example, in an offline consumption scenario, it is common to position the users by using an indoor positioning method and then push various information such as special offers and sales promotion to the users according to the positioning result. A simpler positioning method is a fingerprint database based positioning method.

A process of a fingerprint database based positioning method in the conventional techniques is as follows: a mobile terminal may detect a nearby base station signal and/or WI-FI signal and send the base station signal and/or WI-FI signal to a server, and the server queries a corresponding location point stored in a fingerprint database in the server according to the base station signal and/or WI-FI signal, and sends the query result to the mobile terminal, to achieve positioning. Such a positioning manner is more suitable for positioning users in a stationary state. However, the users are generally in a motion state, and with the motion of the users, the collected location fingerprint data may change constantly, which may result in that the positioning result is not accurate enough.

In view of the above problems, the present disclosure further provides a positioning method, of which the main principle is as follows: combining a fingerprint database based positioning method with a sensor data based step-counting process, to accurately position the location of a user.

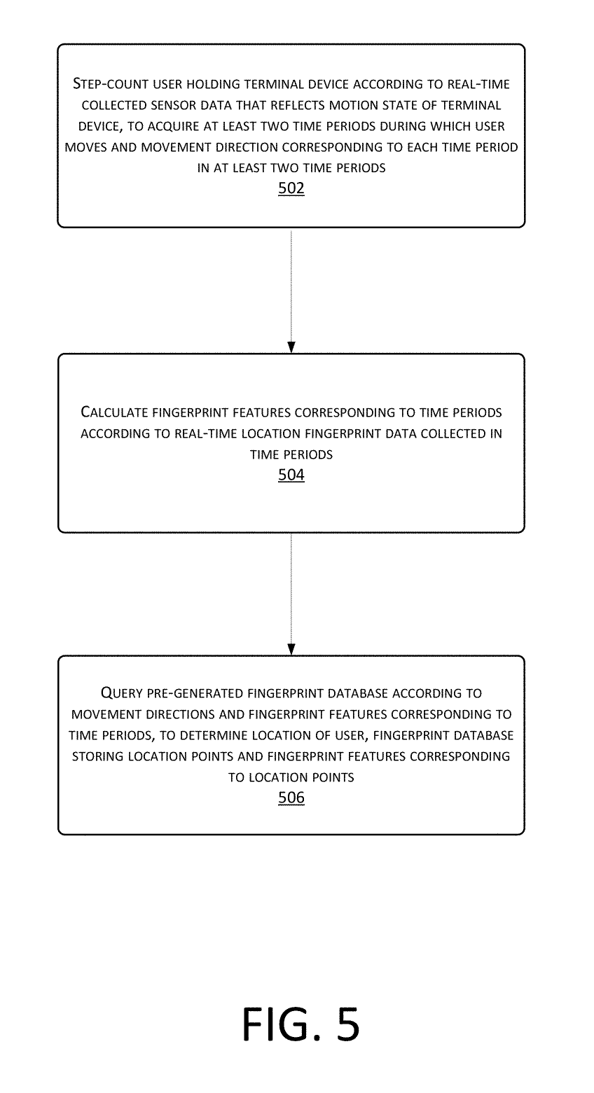

FIG. 5 is a schematic flow chart of a fingerprint database based positioning method according to further another example embodiment of the present disclosure. As shown in FIG. 5, the method includes:

502. The present techniques step-count a user holding a terminal device according to real-time collected sensor data that reflects a motion state of the terminal device, to acquire at least two time periods during which the user moves and a movement direction corresponding to each time period in the at least two time periods.

504. The present techniques calculate fingerprint features corresponding to the time periods according to real-time location fingerprint data collected in the time periods.

506. The present techniques query a pre-generated fingerprint database according to the movement directions and the fingerprint features corresponding to the time periods, to determine the location of the user, the fingerprint database storing location points and fingerprint features corresponding to the location points.

This example embodiment provides a fingerprint database based positioning method, which may be performed by a fingerprint database based positioning apparatus (hereinafter referred to as a positioning apparatus for short). The positioning apparatus of this example embodiment may be located in a client terminal to implement an offline positioning method, or may be located in a server terminal to implement an online positioning method.

The offline positioning method refers to a method of downloading a fingerprint database to a client terminal locally and performing positioning processing by the client terminal based on the local fingerprint database. Correspondingly, the online positioning method refers to a method of uploading, by a client terminal, collected data to a server terminal where a fingerprint database is located, and performing positioning processing by the server terminal.

It should be noted that the fingerprint database used in this example embodiment may be constructed by using the methods described in the above example embodiments, but is not limited thereto. For example, the fingerprint database used in this example embodiment may also be constructed with an existing method. For instance, it is feasible to go to the site to manually collect location fingerprint data near a specified location point by using dedicated collection software or a dedicated collection device, and then extract a fingerprint feature of the location point from the collected location fingerprint data and store the fingerprint feature and the location point in a corresponding manner, to generate a fingerprint database.

In this example embodiment, on one hand, it is necessary to step-count the user based on sensor data, and thus it is necessary to collect sensor real-time data that reflects a motion state of a terminal device. For example, the corresponding sensor data is collected by using a sensor on the terminal device. On the other hand, it is necessary to perform positioning processing on the user based on the fingerprint database, and thus it is necessary to collect location fingerprint data in real-time at the location of the user.

If the positioning apparatus is implemented in a client terminal, the positioning apparatus collects sensor data in real time by using a sensor on the terminal device, and collect location fingerprint data at the location of the user in real time.

If the positioning apparatus is implemented in a server terminal, the client terminal collects sensor data by using a sensor on the terminal device in real time, collects location fingerprint data at the location of the user in real time, and then uploads the real-time collected sensor data and location fingerprint data to the positioning apparatus, and the positioning apparatus may specifically receive the sensor data and the location fingerprint data that are collected and uploaded by the client terminal in real time.

After the sensor data and the location fingerprint data are collected, the positioning apparatus step-counts the user holding the terminal device according to the collected real-time sensor data that reflects a motion state of the terminal device, to acquire at least two time periods during which the user moves and a movement direction corresponding to each time period in the at least two time periods. Herein, the time period during which the user moves refers to a time period corresponding to one step of movement of the user. The movement direction corresponding to each time period refers to a movement direction in which the user moves by one step in each time period.

In a specific implementation, in order to improve the accuracy of step-counting, at least two types of sensor data can be used to step-count the user, and the sensor data is further filtered to filter out noise in the sensor data, which further improves accuracy of step-counting and improves the accuracy of subsequent user positioning based on the step-counting result. Based on this, one implementation of the step 502 includes:

collecting at least two types of sensor data that reflect a motion state of a terminal device in real-time;

filtering the at least two types of sensor data respectively, to obtain filtered sensor data; and

step-counting a user according to the filtered sensor data, to acquire at least two time periods during which the user moves and a movement direction corresponding to each time period in the at least two time periods.

For example, low-pass filtering and/or mean filtering may be performed on each type of sensor data, but it is not limited thereto.

The formula of the low-pass filtering algorithm is as follows:

Y(n)=a*X(n)+(1−a)*Y(n−1)

In the above formula, X(n) denotes currently collected sensor data; Y(n−1) denotes filtered sensor data output after the filtering processing at a previous moment; a denotes a filter coefficient, the value of which is generally much less than 1; and Y(n) denotes current filtered sensor data output after the filtering processing.

The terminal device generally has a variety of inertial sensors, for example, an acceleration sensor, a gyroscope, an electronic compass and the like. These inertial sensors detect the motion state of the terminal device. Generally, different inertial sensors are used for detecting different state parameters. For example, the acceleration sensor may detect an acceleration value of the terminal device, the gyroscope may detect an angular velocity value of the terminal device, and the electronic compass may detect a magnetic field vector value of the terminal device.

It should be noted that the magnetic field vector value of the terminal device may be converted to an angular velocity value, and is the same as the angular velocity value. Therefore, this example embodiment of the present disclosure is mainly described by taking an example that the sensor data reflecting the motion state of the terminal device includes acceleration values and angular velocity values.

For example, it is necessary to collect acceleration values and angular velocity values that reflect the motion state of the terminal device in real-time; filter the acceleration values and the angular velocity values, to obtain filtered acceleration values and angular velocity values; and step-count the user according to the filtered acceleration values and angular velocity values, to acquire at least two time periods during which the user moves and a movement direction corresponding to each time period in the at least two time periods.

Further, the implementation of step-counting the user according to the filtered acceleration values and angular velocity values to acquire at least two time periods during which the user moves and a movement direction corresponding to each time period in the at least two time periods includes:

acquiring, from the filtered acceleration values, adjacent maximum values and minimum values as extremum pairs;

acquiring, from the extremum pairs, extremum pairs that meet a preset step-counting condition as effective extremum pairs; and

acquiring, from the effective extremum pairs, at least two target extremum pairs, determining a time period defined by each target extremum pair in the at least two target extremum pairs, and acquiring, from the filtered angular velocity values, an angular velocity value collected in the time period defined by each target extremum pair. The angular velocity value collected in the time period defined by each target extremum pair denotes the movement direction corresponding to the time period.

Generally, the acceleration value of the terminal device may reflect whether the user moves. Theoretically, each time an extremum pair is found in the acceleration values of the terminal device, it indicates that the user moves by one step. However, actually there exists such a situation that the user does not move while the terminal device has an acceleration such that the user turns around or lifts an arm or the like to cause the location of the terminal device to change. In order to more precisely identify whether the user moves, in this implementation, a step-counting condition is preset, extremum pairs are filtered according to the step-counting condition to acquire an effective extremum pair, and the effective extremum pair is used for indicating that the user moves by one step.

It can be known with reference to the actual situation during movement of the user that, each time the user moves by one step generally requires a particular period of time and each step has a particular amplitude. The time required by the user to move by one step may be denoted by a time period defined by an extremum pair, and the amplitude of the movement of the user may be denoted by the amplitude of the extremum pair. The time period defined by the extremum pair refers to a period of time between a time point at which the maximum value in the extremum pair appears and a time point at which the minimum value in the extremum pair appears. Based on this, the preset step-counting condition includes: an extremum range and a time range. For example, the extremum range may be, but is not limited to: [g+0.5, g+5], wherein g denotes the gravity coefficient and is a constant. The time range, for example, may be, but is not limited to: [300 ms, 1100 ms]. Wherein, the time range may be an average value obtained by conducting statistics on a time period required by lots of users to move by one step, but is not limited thereto.

Based on the above, for each extremum pair, it is feasible to judge whether absolute values of the maximum value and the minimum value in the extremum pair are in the extremum range, and to judge whether the time period defined by the extremum pair is in the time range; if the judgment results are both yes, it indicates that the amplitude of the maximum value and the minimum value and time defined by the extremum pair are both in line with the situation where the user moves by one step. Therefore, the extremum pair is determined as an effective extremum pair, thereby determining that the user moves by one step in the time period defined by the extremum pair. If one of the judgment results is no, it is determined that the user does not move.

It should be noted that the process of judging whether absolute values of the maximum value and the minimum value in the extremum pair are in the extremum range and the process of judging whether a time period defined by the extremum pair is in the time range may be performed in any order or may be performed in parallel.

Each time an effective extremum pair is acquired, it is determined that the user moves by one step in a time period defined by the effective extremum pair. When the user moves, in addition to the distance of the movement, the direction may generally change. Therefore, when determining that the user moves by one step, the positioning apparatus may further acquire, from the filtered angular velocity values, an angular velocity value collected in the time period defined by the effective extremum pair as a movement direction of the user.

For example, in the process of collecting the angular velocity values, in addition to recording the collected angular velocity values, information such as time when the angular velocity values are collected may also be recorded. Based on this, the positioning apparatus may search the filtered angular velocity values according to a time range defined by the maximum value and the minimum value in the effective extremum pair, to acquire an angular velocity value collected in the time.

It should be noted that, if the angular velocity values are collected at an excessively low frequency, it is possible that the angular velocity value collected in the time period defined by the effective extremum pair cannot be found. In this case, a missing report may be caused, that is, one step of movement of the user is omitted due to the absence of the angular velocity value, but actually the user moves by one step indeed. In order to avoid such missing report and improve the positioning accuracy, if the filtered angular velocity values do not include the angular velocity value collected in the time period defined by the effective extremum pair, an angular velocity value collected in a time period defined by a previous effective extremum pair is angle-shifted, and the shifted angular velocity value is used as the angular velocity value generated in the time period defined by the current effective extremum pair. Optionally, the shifted angular velocity value is filled into a corresponding position in the filtered angular velocity values, to achieve supplement of the angular velocity values.

It should be noted that the angle-shifting an angular velocity value collected in a time period defined by a previous effective extremum pair may be angle-shifting an angular velocity value collected in a time period defined by one or more effective extremum pairs prior to the current effective extremum pair.

Optionally, the angle-shifting may be shifting the angular velocity value collected in the time period defined by the previous effective extremum pair in a clockwise direction, for example, a preset shift angle is 3 degrees, and the angular velocity value collected in the time period defined by the previous effective extremum pair may be shifted by 3 degrees in the clockwise direction, but the preset shift angle is not limited to this shift angle.

After the effective extremum pair is obtained, the time period defined by each effective extremum pair and the corresponding movement direction may be acquired for positioning the user, which, however, is not limited thereto. For example, the effective extremum pairs may also be sampled, such that time periods defined by the effective extremum pairs and the corresponding movement directions are acquired at intervals.

After a time period for positioning the user is determined, it is feasible to acquire, from the real-time collected location fingerprint data, location fingerprint data collected in each time period, and then extract a fingerprint feature according to the location fingerprint data collected in each time period, which is referred to as a fingerprint feature corresponding to each time period. For example, numerical processing may be performed on the location fingerprint data collected in each time period, to obtain the fingerprint feature corresponding to each time period. Manners of the numerical processing include, but not limited to: arithmetically averaging all the location fingerprint data, or arithmetically averaging the location fingerprint data remained after removal of the maximum value and the minimum value, or arithmetically averaging the maximum value and the minimum value, and so on.

Then, a pre-generated fingerprint database is queried according to the movement direction and the fingerprint feature corresponding to each time period, to determine the location of the user.

Specifically, it is feasible to query the fingerprint database according to a fingerprint feature corresponding to the first time period in the time periods, to determine an initial location point, the initial location point being a location point corresponding to a fingerprint feature, in the fingerprint database, which meets a preset matching condition with a fingerprint feature corresponding to the first time period. The preset matching condition may be that the fingerprint features are the same or a difference is in a specified range. Then, a time period next to the first time period in the time periods is used as a target time period; the time period next to the first time period refers to a time period after the first time period according to a time sequence. Then, the fingerprint database is queried according to a movement direction and a fingerprint feature corresponding to the target time period, to determine a transitional location point. The transitional location point refers to a location point, of which the fingerprint feature in the fingerprint database meets the preset matching condition with the fingerprint feature corresponding to the target time period, and of which a direction relation with the initial location point is the same as the movement direction corresponding to the target time period. Then, whether there is a time period next to the target time period is judged; if there is a time period next to the target time period, the transitional location point is used as a new initial location point, the time period next to the target time period is used as a new target time period, and the process returns to continue with the operation of querying the fingerprint database according to a movement direction and a fingerprint feature corresponding to the target time period, to determine a transitional location point. If there is no time period next to the target time period, the current transitional location point is acquired as the location of the user.

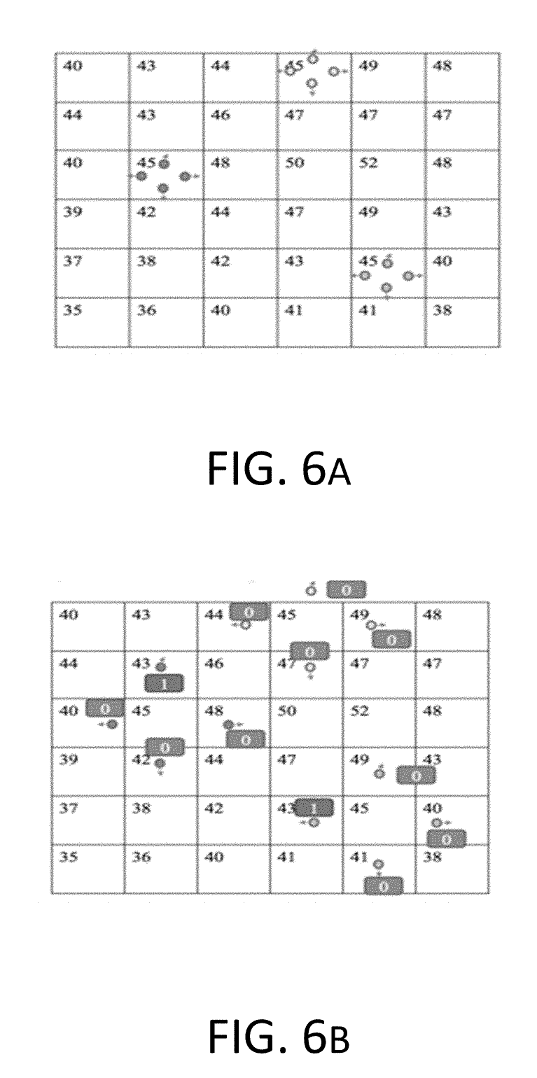

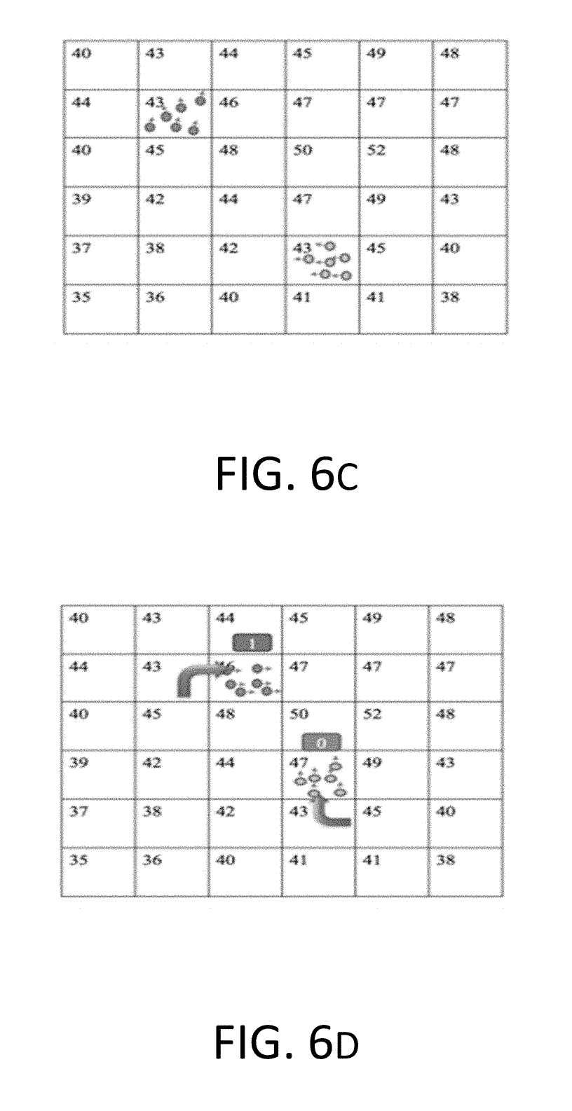

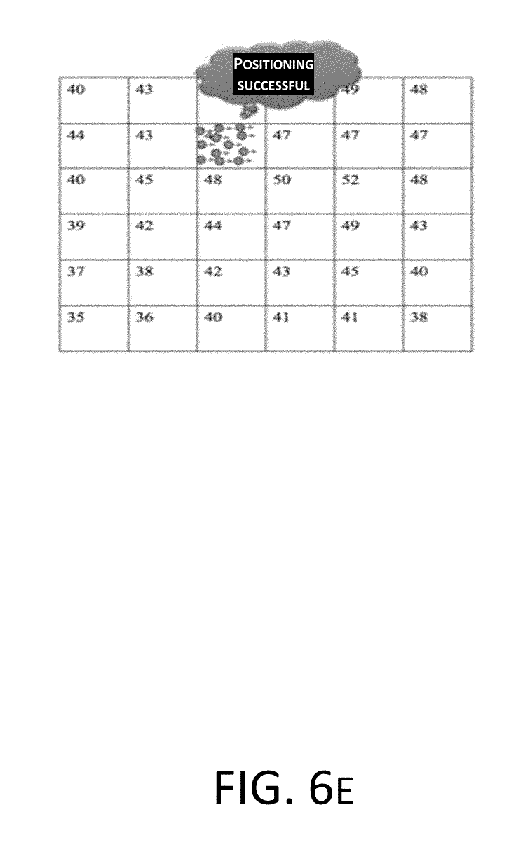

The above implementation is described in detail below in combination with FIGS. 6a-6e and by taking the location fingerprint data being magnetic field strength as an example. In FIGS. 6a-6e, the entire big block indicates a region corresponding to the fingerprint database, and the small boxes in the big block indicate specific location points.

Assuming that a fingerprint feature calculated according to collected magnetic field strength in a first time period is, for example, an average magnetic field strength of 45, a search is conducted in the fingerprint database according to the condition, and the search result is as shown in FIG. 6a.

If a fingerprint feature calculated according to collected magnetic field strength in a second time period is, for example, an average magnetic field strength of 43 and the movement direction is 0 degree, a search is conducted in the fingerprint database according to the condition, the search process is as shown in FIG. 6b, the arrows in FIG. 6b indicate possible location points, and the final search result is as shown in FIG. 6c.

If a fingerprint feature calculated according to collected magnetic field strength in a third time period is, for example, an average magnetic field strength of 46 and the movement direction is −90 degrees, a search is conducted in the fingerprint database according to the condition, the search process is as shown in FIG. 6d, the arrows in FIG. 6d indicate possible location points, and the final search result is as shown in FIG. 6e.

Further, the determined location of the user may also be corrected according to a constraint condition (e.g., a step-counting condition) in the step-counting process. For example, assuming that the user moves by one step, theoretically, the distance between two location points does not exceed a conventional step length, and if the positioned location is at a farther distance from the previous location point, for example, at a distance of 1 m, which is far beyond the distance of one-step movement of the user, it is determined that the positioning result is incorrect and the positioned location of the user is not accurate.

It is thus clear that this example embodiment combines a fingerprint database based positioning method with a sensor data based step-counting process, accurately positions the location of a user, and is suitable for indoor positioning of a user in a motion state. Certainly, the method provided in this example embodiment is also suitable for indoor positioning of a user in a stationary state, and the stationary state may be regarded as a special motion state. In addition, the method may also be suitable for outdoor positioning in addition to indoor positioning.

The positioning method provided in this method does not need to know the initial location (which is generally provided by another positioning method, e.g., a base station based positioning method) of the user in advance, gradually narrows down possible location points with a method of continuous convergence, and finally determines the location of the user, which does not rely on other positioning methods, would not be affected by the positioning accuracy of other positioning methods, has higher positioning accuracy and is very flexible.

For example, the fingerprint database based positioning method provided in this example embodiment may rely on the fingerprint database provided in the foregoing example embodiment. This can improve the positioning efficiency and accuracy of the entire positioning system.

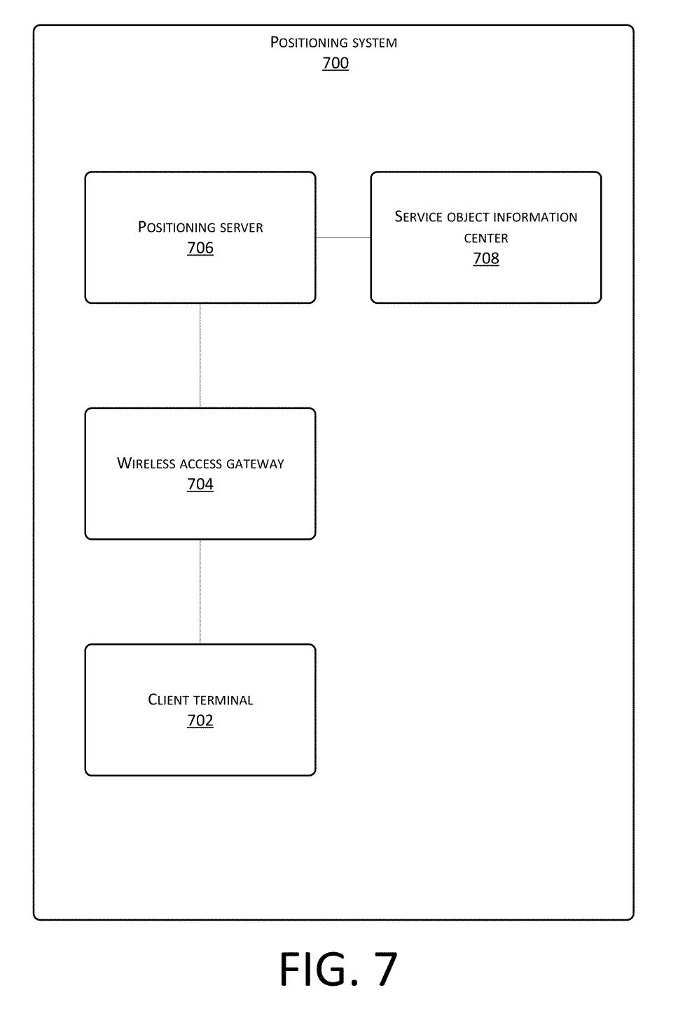

An example positioning system 700 combining the fingerprint database constructed in the above example embodiment with the fingerprint database based positioning method provided in this example embodiment is as shown in FIG. 7. The positioning system 700 mainly includes a client terminal 702, a wireless access gateway 704, a positioning server 706, and a service object information center 708. Further, the positioning system 700 may also include: a user management center, a terminal device information center and so on (not shown in FIG. 7). As this example embodiment does not focus on the user management center and the terminal device information center, they are not shown in FIG. 7. Reference may be made to the example embodiments shown in FIG. 1 and FIG. 2 for the process of constructing a fingerprint database by the positioning system, and reference may be made to the example embodiment shown in FIG. 5 for the process of positioning a user, which are not repeated herein.

For example, in an offline consumption scenario, the client terminal is an application having a payment function such as Alipay™ or WeChat, the positioning server is a payment platform, and the service object information center may be a business information center.

It should be noted that, to make the description simple, the method example embodiments are expressed as a combination of a series of actions. However, those skilled in the art should know that the present disclosure is not limited by the described action order, because some steps may be performed in other orders or at the same time according to the present disclosure. Secondly, those skilled in the art should also know that the example embodiments described in the specification are all preferred example embodiments, and the actions and modules involved are not necessarily mandatory for the present disclosure.

In the foregoing example embodiments, the description of each example embodiment has its own focus; for the content that is not detailed in a certain example embodiment, reference can be made to the relevant description of another example embodiment.

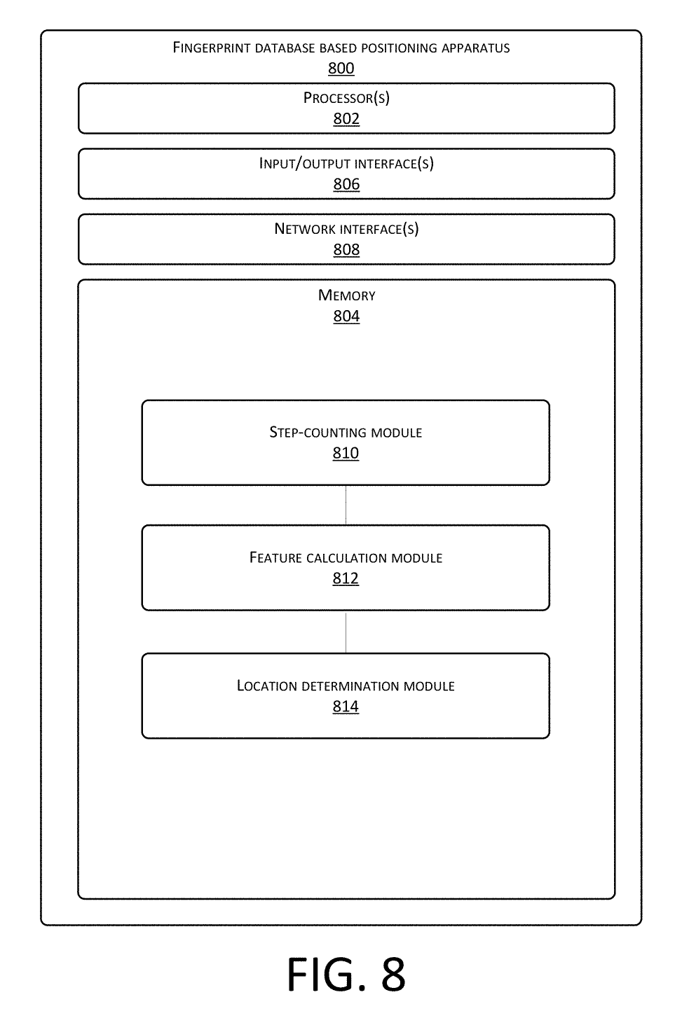

FIG. 8 is a schematic structural diagram of a fingerprint database based positioning apparatus 800 according to further another example embodiment of the present disclosure. As shown in FIG. 8, the apparatus 800 may include one or more processor(s) 802 or data processing unit(s) and memory 804. The fingerprint database based positioning apparatus 800 may further include one or more input/output interface(s) 806, and network interface(s) 808. The memory 804 is an example of computer readable media.

The memory 804 may store therein a plurality of modules or units including a step-counting module 810, a feature calculation module 812, and a location determination module 814.

The step-counting module 810 is configured to step-count a user holding a terminal device according to real-time collected sensor data that reflects a motion state of the terminal device, to acquire at least two time periods during which the user moves and a movement direction corresponding to each time period in the at least two time periods.

The feature calculation module 812 is configured to calculate fingerprint features corresponding to the time periods according to location fingerprint data real-time collected in the time periods.

The location determination module 814 is configured to query a pre-generated fingerprint database according to the movement directions and the fingerprint features corresponding to the time periods, to determine the location of the user, the fingerprint database storing location points and fingerprint features corresponding to the location points.

In an optional implementation, the step-counting module 810 includes: an acquisition unit, a filtering unit, and a step-counting unit.

The acquisition unit is configured to collect at least two types of sensor data that reflect the motion state of the terminal device in real time.

The filtering unit is configured to filter the at least two types of sensor data, respectively, to obtain filtered sensor data.

The step-counting unit is configured to step-count the user according to the filtered sensor data, to acquire the time periods and the movement directions corresponding to the time periods.

In an optional implementation, the at least two types of sensor data include acceleration values and angular velocity values. Correspondingly, the filtered sensor data includes: filtered acceleration values and filtered angular velocity values.

Based on the above, the step-counting unit is specifically configured to:

acquire, from the filtered acceleration values, adjacent maximum values and minimum values as extremum pairs;

acquire, from the extremum pairs, extremum pairs that meet a preset step-counting condition as effective extremum pairs; and

acquire, from the effective extremum pairs, at least two target extremum pairs, determine a time period defined by each target extremum pair in the at least two target extremum pairs, and acquire, from the filtered angular velocity values, an angular velocity value collected in the time period defined by each target extremum pair.

In an optional implementation, the location determination module 814 is specifically configured to:

query the fingerprint database according to a fingerprint feature corresponding to a first time period in the time periods, to determine an initial location point, the initial location point being a location point corresponding to a fingerprint feature, in the fingerprint database, which meets a preset matching condition with a fingerprint feature corresponding to the first time period;

use a time period next to the first time period in the time periods as a target time period;

query the fingerprint database according to a movement direction and a fingerprint feature corresponding to the target time period, to determine a transitional location point, the transitional location point being a location point, of which the fingerprint feature in the fingerprint database and the fingerprint feature corresponding to the target time period meet the matching condition and of which a direction relation with the initial location point is the same as the movement direction corresponding to the target time period;

if there is a time period next to the target time period, use the transitional location point as a new initial location point, use the time period next to the target time period as a new target time period, and return to continue with the operation of querying the fingerprint database according to a movement direction and a fingerprint feature corresponding to the target time period, to determine a transitional location point; and

acquire the transitional location point as the location of the user if there is no time period next to the target time period.

Further, the fingerprint database based positioning apparatus 800 provided in this example embodiment may include a constructing module (not shown in FIG. 8).

The constructing module is configured to construct the fingerprint database by using the method shown in FIG. 1 and FIG. 2. Reference may be made to the implementation of the structure of the fingerprint database constructing apparatus shown in FIG. 4 for the implementation structure of the constructing module, which is not repeated in detail.

The positioning apparatus provided in this example embodiment may be implemented in a client terminal, and may also be implemented in a server terminal.

The positioning apparatus provided in this example embodiment combines the fingerprint database based positioning method with the sensor data based step-counting process, thus accurately positioning the location of the user.

Those skilled in the art can clearly understand that, in order to make the description convenient and concise, reference can be made to the corresponding process in the foregoing method example embodiments for the specific working procedures of the system, apparatuses, and units described above, which are not repeated herein.

In the several example embodiments provided in the present disclosure, it should be understood that the disclosed system, apparatuses, and methods may be implemented in another manner. For example, the described apparatus example embodiments are only exemplary. For example, the division of the units is merely a logical function division and there may be other division manners in actual implementation, for example, a plurality of units or components may be combined or integrated into another system, or some features may be ignored or not performed. In addition, the displayed or discussed mutual coupling or direct coupling or communication connections may be indirect coupling or communication connections implemented by using some interfaces, apparatuses or units, and may be implemented electrically, mechanically or in another form.

The units described as separate parts may or may not be physically separate, and parts displayed as units may or may not be physical units, that is, they may be located in one position, or may be distributed on a plurality of network units. Some or all of the units may be selected according to actual needs to achieve the objectives of the solutions of the example embodiments.

In addition, functional units in the example embodiments of the present disclosure may be integrated into one processing unit, or each of the units may exist alone physically, or two or more units are integrated into one unit. The integrated unit may be implemented in a form of hardware, or may be implemented in a form of hardware plus a software functional unit.

The integrated unit implemented in the form of a software functional unit may be stored in computer readable media. The software functional unit is stored in a storage medium, and includes several instructions for instructing a computer device (which may be a personal computer, a server, or a network device) or a processor to perform some of the steps of the methods described in the example embodiments of the present disclosure. The foregoing storage medium includes: various media that can store program codes, such as a USB flash disk, a removable hard disk, a Read-Only Memory (ROM), a Random Access Memory (RAM), a magnetic disk, or an optical disc.

The computer readable medium includes volatile and non-volatile, removable and non-removable media, and can use any method or technology to store information. The information may be a computer readable instruction, a data structure, a module of a program or other data. Examples of storage mediums of a computer include, but are not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storage, a cassette tape, a tape disk storage or other magnetic storage devices, or any other non-transmission mediums, which can be used for storing information accessible to the computation device. According to the definition herein, the computer readable medium does not include transitory media such as a modulated data signal and a carrier.

Finally, it should be noted that the above example embodiments are merely provided for describing the technical solutions of the present disclosure, but are not intended to limit the present disclosure. It should be understood by those of ordinary skill in the art that, although the present disclosure has been described in detail with reference to the foregoing example embodiments, modifications can be made to the technical solutions described in the foregoing example embodiments, or equivalent replacements can be made to some technical features in the technical solutions; such modifications or replacements do not cause the essence of the corresponding technical solutions to depart from the spirit and scope of the technical solutions of the example embodiments of the present disclosure.

What is claimed is:

1. A method comprising:
collecting, by a client terminal, location fingerprint data at a location of a target service object, the target service object being a service object having a service relationship with the client terminal;
sending, by the client terminal, a service request to a server terminal; and
sending the location fingerprint data to the server terminal in the process of sending the service request.

2. The method of claim 1, further comprising generating, by the server terminal, a fingerprint database according to the service request and the location fingerprint data.

3. The method of claim 1, wherein the service request includes indication information indicative of the location of the target service object.

4. The method of claim 1, wherein the location fingerprint data includes at least one of following types:
Wi-FI signal strength;
Bluetooth signal strength;
base station signal strength; and
geomagnetic signal strength.

5. The method of claim 1, wherein the indication information is an identifier of the target service object.

6. The method of claim 1, wherein:
the target service object is a physical store; and
the service request is a payment request or a download request.

7. A method comprising:
receiving, by a server terminal, one or more service requests sent by one or more client terminals having a service relationship with a target service object;
receiving location fingerprint data sent by the client terminals at the location of the target service object in the process of sending the service requests, the service request including indication information indicative of the location of the target service object;
determining a location of the target service object according to the indication information;
using the location of the target service object as a location point corresponding to the location fingerprint data;
acquiring a fingerprint feature corresponding to the location point according to the location fingerprint data; and
establishing a corresponding relationship between the location point and the fingerprint feature to generate a fingerprint database.

8. The method of claim 7, wherein:
the acquiring a fingerprint feature corresponding to the location point according to the location fingerprint data includes performing numerical processing on various types of location fingerprint data to obtain various types of fingerprint features; and
the establishing the corresponding relationship between the location point and the fingerprint feature to generate the fingerprint database includes establishing a corresponding relationship between the location point and the various types of fingerprint features to generate the fingerprint database.

9. The method of claim 7, further comprising:
acquiring new location fingerprint data at the location of the target service object; and
updating the fingerprint database according to the new location fingerprint data.

10. The method of claim 7, wherein:
the indication information is an identifier of the target service object; and
the determining the location of the target service object according to the indication information includes searching in a map according to the identifier of the target service object to determine the location of the target service object.

11. The method of claim 7, wherein:
the indication information is an identifier of the target service object; and
the determining the location of the target service object according to the indication information includes querying a preset corresponding relationship between object identifiers and object locations according to the identifier of the target service object to determine the location of the target service object.

12. The method of claim 7, wherein:
the target service object is a physical store; and
the service request is a payment request or a download request.

13. A method comprising:
step-counting a user holding a terminal device according to collected real-time sensor data that reflects a motion state of the terminal device to acquire at least two time periods during which the user moves and a movement direction corresponding to each time period in the at least two time periods;
calculating fingerprint features corresponding to the time periods according to location fingerprint data real-time collected in the time periods; and
querying a pre-generated fingerprint database according to the movement direction and the fingerprint features corresponding to the time periods to determine the location of the user, the fingerprint database storing location points and fingerprint features corresponding to the location points.

14. The method of claim 13, wherein the step-counting the user holding the terminal device according to collected real-time sensor data that reflects the motion state of the terminal device to acquire at least two time periods during which the user moves and the movement direction corresponding to each time period in the at least two time periods includes:
collecting at least two types of sensor data that reflect the motion state of the terminal device in real-time;
filtering the at least two types of sensor data respectively to obtain filtered sensor data; and
step-counting the user according to the filtered sensor data to acquire the time periods and the movement directions corresponding to the time periods.

15. The method of claim 14, wherein the at least two types of sensor data include an acceleration value and an angular velocity value.

16. The method of claim 14, wherein:
the filtered sensor data includes filtered acceleration values and filtered angular velocity values.

17. The method of claim 16, wherein the step-counting the user according to the filtered sensor data to acquire the time periods and the movement directions corresponding to the time periods includes:
acquiring, from the filtered acceleration values, adjacent maximum values and minimum values as extremum pairs;
acquiring, from the extremum pairs, extremum pairs that meet a preset step-counting condition as effective extremum pairs; and
acquiring, from the effective extremum pairs, at least two target extremum pairs, determining a time period defined by each target extremum pair in the at least two target extremum pairs, and acquiring, from the filtered angular velocity values, an angular velocity value collected in the time period defined by each target extremum pair.

18. The method of claim 13, wherein the querying the pre-generated fingerprint database according to the movement directions and the fingerprint features corresponding to the time periods to determine the location of the user includes:
querying the fingerprint database according to a fingerprint feature corresponding to a first time period in the time periods to determine an initial location point, the initial location point being a location point corresponding to a fingerprint feature, in the fingerprint database, which meets a preset matching condition with a fingerprint feature corresponding to the first time period;
using a time period next to the first time period in the time periods as a target time period;
querying the fingerprint database according to a movement direction and a fingerprint feature corresponding to the target time period, to determine a transitional location point, the transitional location point being a location point, of which the fingerprint feature in the fingerprint database and the fingerprint feature corresponding to the target time period meet the matching condition and of which a direction relation with the initial location point is the same as the movement direction corresponding to the target time period.

19. The method of claim 18, further comprising:
determining whether there is a time period next to the target time period; and
in response to determining that there is the time period next to the target time period, using the transitional location point as a new initial location point; and
using the time period next to the target time period as a new target time period, and returning to continue with the operation of querying the fingerprint database according to a movement direction and a fingerprint feature corresponding to the target time period, to determine a transitional location point.

20. The method of claim 18, further comprising:
determining whether there is a time period next to the target time period; and
in response to determining that there is no time period next to the target time period, acquiring the transitional location point as the location of the user if there is no time period next to the target time period.
